(19) United States
(12) Patent Application Publication
(10) Pub. No.: US 2020/0130212 A1
(43) Pub. Date: Apr. 30, 2020

(54) CARPENTERS FINGER SLEEVE ASSEMBLY

(71) Applicant: Angelo Mantello, Brooklyn, NY (US)

(72) Inventor: Angelo Mantello, Brooklyn, NY (US)

(21) Appl. No.: 16/176,421

(22) Filed: Oct. 31, 2018

(51) Int. Cl. B26B 29/06; A41D 13/08

(52) U.S. Cl. CPC B26B 29/06; A41D 2300/22; A41D 2600/20; A41D 13/087

(57) ABSTRACT

A carpenter's finger sleeve assembly for protecting a carpenter's finger from being cut while scoring a surface includes a sleeve that is wearable on an end of an index finger. The sleeve is comprised of a cut resistant material to protect the end of the index finger from being cut. The sleeve is comprised of a friction inhibiting material to enhance the index finger's ability to slide along a surface. A panel is coupled to and extends laterally away from the sleeve and the panel is positioned against a blade of a knife when the sleeve is worn. In this way the panel can guide the blade along the surface for scoring the surface.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to sleeve devices and more particularly pertains to a new sleeve device for protecting a carpenter's finger from being cut while scoring a surface.

### BRIEF SUMMARY OF THE INVENTION

An embodiment of the disclosure meets the needs presented above by generally comprising a sleeve that is wearable on an end of an index finger. The sleeve is comprised of a cut resistant material to protect the end of the index finger from being cut. The sleeve is comprised of a friction inhibiting material to enhance the index finger's ability to slide along a surface. A panel is coupled to and extends laterally away from the sleeve and the panel is positioned against a blade of a knife when the sleeve is worn. In this way the panel can guide the blade along the surface for scoring the surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a carpenter's finger sleeve assembly according to an embodiment of the disclosure.

FIG. 2 is a right side view of an embodiment of the disclosure.

FIG. 3 is a bottom view of an embodiment of the disclosure.

FIG. 4 is a back view of an embodiment of the disclosure.

FIG. 5 is a cross sectional view taken along line 5-5 of FIG. 3 of an embodiment of the disclosure.

### DETAILED DESCRIPTION OF THE INVENTION

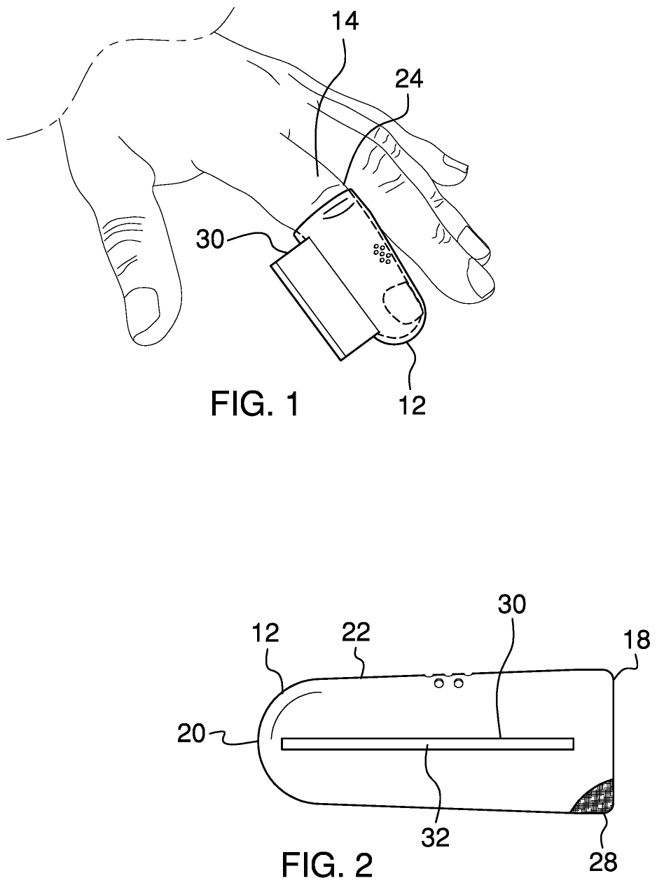

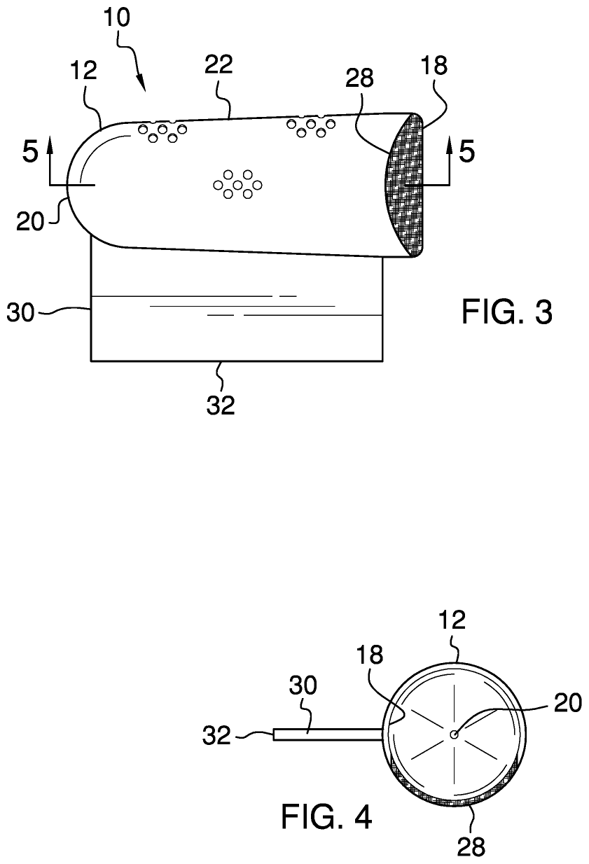

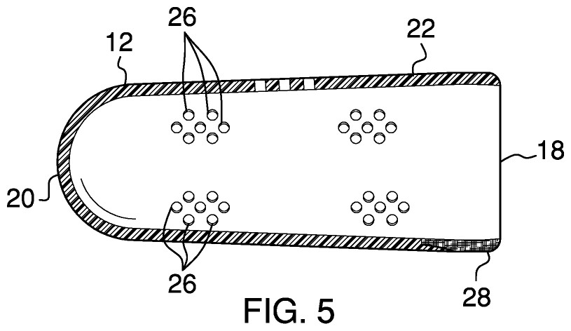

With reference now to the drawings, and in particular to FIGS. 1 through 5 thereof, a new sleeve device embodying the principles and concepts of an embodiment of the disclosure and generally designated by the reference numeral 10 will be described.

As best illustrated in FIGS. 1 through 5, the carpenter's finger sleeve assembly 10 generally comprises a sleeve 12 that is wearable on an end of an index finger 14. The sleeve 12 is comprised of a cut resistant material to protect the end of the index finger 14 from being cut. Additionally, the sleeve 12 is comprised of a friction inhibiting material to enhance the index finger 14's ability to slide along a surface. Thus, the sleeve 12 is useful for carpenters to wear when cutting or scoring sheetrock, tile and other types of panels.

The sleeve 12 has a first end 18, a second end 20 and an outer wall 22 extending therebetween. The second end 20 is closed, and the second end 20 is rounded for accommodating a tip of the index finger 14. The first end 18 of the sleeve 12 is aligned with a knuckle 24 between a middle phalanx and a proximal phalanx of the index finger 14 when the sleeve 12 is worn. Thus, the sleeve 12 does not impede the natural motion of the index finger 14 with respect to bending. The sleeve 12 has a plurality of air holes 26 each extending therethrough. Each of the air holes 26 passes air therethrough thereby allowing skin on the index finger 14 to breathe when the sleeve 12 is worn. The air holes 26 may be arranged into a plurality of groups of seven air holes 26 such that each of the groups of seven air holes 26 forms a hexagonal shape.

The outer wall 22 of the sleeve 12 has an elastic portion 28 extending from the first end 18 toward the second end 20. The elastic portion 28 is positioned on a bottom side of the index finger 14 when the sleeve 12 is worn. In this way the elastic portion 28 facilitates the knuckle 24 between the distal and middle phalanxes to bend. The elastic portion 28 may be comprised of any resiliently stretchable material, such as spandex or the like.

A panel 30 is coupled to and extends laterally away from the sleeve 12. The panel 30 is positioned against a blade of a knife when the sleeve 12 is worn. The knife may be a utility knife or other similar knife employed in the construction industry. In this way the panel 30 can guide the blade along the surface 16 for scoring the surface 16. The panel 30 is positioned on the outer wall 22 of the sleeve 12 and the panel 30 has a distal edge 32 with respect to the outer wall 22. The distal edge 32 lies on a horizontal line when the sleeve 12 is worn and the sleeve 12 is positioned against a horizontal surface 16. Moreover, the distal edge 32 lies on a vertical line when the sleeve 12 is worn and the sleeve 12 is positioned against a vertical surface 16.

In use, the sleeve 12 is worn by a carpenter or other individual when a plurality of cuts or scoring lines is to be accomplished on sheetrock, tile or other type of panel. The blade of the knife is positioned against the distal edge 32 of the panel 30 and the sleeve 12 slides along the surface 16 while the blade cuts or scores the surface 16. Thus, not only is the blade of the knife guided but the index finger 14 is protected from being cut by the blade. Additionally, the elastic portion 28 of the outer wall 22 of the sleeve 12 facilitates full motion of the index finger 14 when the sleeve 12 is worn.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A carpenter's finger sleeve assembly being configured to be worn on a finger thereby defining a straight edge for guiding a cutting blade, said assembly comprising:
a sleeve being wearable on an end of an index finger, said sleeve being comprised of a cut resistant material wherein said sleeve is configured to protect the end of the index finger from being cut, said sleeve being comprised of a friction inhibiting material wherein said sleeve is configured to enhance the index finger's ability to slid along a surface; and
a panel being coupled to and extending laterally away from said sleeve, said panel being positioned against a blade of a knife when said sleeve is worn wherein said panel is configured to guide the blade along the surface for scoring the surface.

2. The assembly according to claim 1, wherein:
said sleeve has a first end, a second end and an outer wall extending therebetween, said second end being closed, said second end being rounded for accommodating a tip of the index finger having said first end being aligned with a knuckle between a middle phalanx and a proximal phalanx of the index finger; and
said sleeve has a plurality of air holes each extending therethrough wherein each of said air holes is configured to pass air therethrough thereby allowing skin on the index finger to breathe when said sleeve is worn.

3. The assembly according to claim 2, wherein said outer wall of said sleeve has an elastic portion extending from said first end toward said second end, said elastic portion being positioned on a bottom side of the index finger when said sleeve is worn wherein said elastic portion is configured to facilitate the knuckle between the distal and middle phalanxes to bend.

4. The assembly according to claim 2, wherein said panel is positioned on said outer wall of said sleeve, said panel having a distal edge with respect to said outer wall, said distal edge lying on a horizontal line when said sleeve is worn and said sleeve is positioned against a horizontal surface, said distal edge lying on a vertical line when said sleeve is worn and said sleeve is positioned against a vertical surface.

5. A carpenter's finger sleeve assembly being configured to be worn on a finger thereby defining a straight edge for guiding a cutting blade, said assembly comprising:
a sleeve being wearable on an end of an index finger, said sleeve being comprised of a cut resistant material wherein said sleeve is configured to protect the end of the index finger from being cut, said sleeve being comprised of a friction inhibiting material wherein said sleeve is configured to enhance the index finger's ability to slid along a surface, said sleeve having a first end, a second end and an outer wall extending therebetween, said second end being closed, said second end being rounded for accommodating a tip of the index finger having said first end being aligned with a knuckle between a middle phalanx and a proximal phalanx of the index finger, said sleeve having a plurality of air holes each extending therethrough wherein each of said air holes is configured to pass air therethrough thereby allowing skin on the index finger to breathe when said sleeve is worn, said outer wall of said sleeve having an elastic portion extending from said first end toward said second end, said elastic portion being positioned on a bottom side of the index finger when said sleeve is worn wherein said elastic portion is configured to facilitate the knuckle between the distal and middle phalanxes to bend; and
a panel being coupled to and extending laterally away from said sleeve, said panel being positioned against a blade of a knife when said sleeve is worn wherein said panel is configured to guide the blade along the surface for scoring the surface, said panel being positioned on said outer wall of said sleeve, said panel having a distal edge with respect to said outer wall, said distal edge lying on a horizontal line when said sleeve is worn and said sleeve is positioned against a horizontal surface, said distal edge lying on a vertical line when said sleeve is worn and said sleeve is positioned against a vertical surface.
